(19) United States
(12) Patent Application Publication
(10) Pub. No.: US 2018/0360053 A1
(43) Pub. Date: Dec. 20, 2018

(54) Procedure for the production of wafer half-shells

(71) Applicant: SOREMARTEC S.A., FINDEL (LU)

(72) Inventors: Luciano MASSA, BRA (Cuneo) (IT); Mathia NEGRO, ASTI (IT)

(73) Assignee: SOREMARTEC S.A., FINDEL (LU)

(21) Appl. No.: 16/007,428

(22) Filed: Jun. 13, 2018

(30) Foreign Application Priority Data
Jun. 14, 2017 (LU) 100316

(51) Int. Cl. A21D 13/36; A21C 15/02; A21D 13/45; A23G 3/54

(52) U.S. Cl. CPC A21D 13/36; A21C 15/02; A23V 2002/00; A23G 3/54; A21D 13/45

(57) ABSTRACT

Method for producing wafer half-shells including the operations of:
providing a wafer including a plurality of half-shells connected to each other by an interconnecting wall, where the interconnecting wall is connected to each half-shell by an annular region surrounding the half-shell having a thickness smaller than the thickness of the interconnecting wall, and
separating the half-shells from the interconnecting wall along a cutting profile corresponding to the half-shell contour at the annular region with a reduced thickness,
   wherein, in the separation operation the interconnecting wall is supported by a plastic material support, and the separation operation is carried out by a cutting member having a serrated cutting profile.

The present invention relates to an industrial process for the production of wafer half-shells or similar food materials of the type used in the confectionery industry for the production of filled foodstuffs formed by a pair of the aforementioned half-shells fitted together mouth-to-mouth and including a filling.

In particular, the invention relates to a method wherein said half-shells are obtained by separation from a wafer sheet having a plurality of half-shells connected to each other by an interconnecting wall, which in turn is connected to each half-shell through an annular region surrounding the half-shell having a thickness smaller than the thickness of the interconnecting wall.

A wafer sheet having the aforementioned characteristics may be obtained, for example, by the process described in WO2011/067733, which is intended to be incorporated herein by reference.

The process described therein uses, for the production of the wafer sheet, a mold comprising a female half-mold and a male half-mold defining jointly a molding cavity for the wafer; the female half-mold comprises a plurality of cells of a shape corresponding to the half-shells to be produced, the front face of which, turned toward the male half-mold, has annular formations projecting towards the front surface of the male half-mold and surrounding each cell, which define in the batter subjected to baking in the molding cavity a notch in the interconnecting wall adjacent to each half-shell.

The wafer sheet resulting from this method has a plurality of half-shells connected to the interconnecting wall by an annular bridge of reduced thickness with respect to the thickness of the interconnecting wall.

As described in WO2011/067733, the half-shells may be separated from the wafer sheet resulting from baking by means of a pressure in the direction orthogonal to the plane of the interconnecting wall; to this end, the solidified wafer sheet may be extracted from the mold and placed on a support having cavities which supports the half-shells or the interconnecting wall, separating the half-shells by means of pressure exerted on the half-shells or respectively on the interconnecting wall.

The half-shells obtained by this method have a finished surface, substantially over their entire wall, as well as on their annular mouth surface (i.e. on the annular surface connecting the inner surface to the outer surface of the half-shell retaining wall), and therefore the baking is done with the batter in contact with the polished surfaces of the two half-molds.

The term ‘finished surface’ means a smooth surface, similar to a skin, substantially free from macropores; the term ‘finished’ being used to distinguish the morphological characteristics of this surface with respect to those of a surface resulting from cutting a wafer wall which, owing to the wafer's porous inner structure, has a macroporous and/or crumbled surface with open cells.

Obtaining half-shells with a finished rim surface is particularly desirable in the production of filled hollow products including a fluid filling, since the presence of matching surfaces with finished rims limits the risk of fluid leakage. Furthermore, the completion of the half-shell with a finished rim is advantageous in the welding process of half-shells by humidifying the matching rims, described in EP-A-1 647 190. It is therefore necessary that the separation operation of the half-shells from the interconnecting wall does not interfere or deteriorate the surface finish of the annular orifice rim of the half-shells.

Although the shape features of a wafer sheet, as described in WO2011/067733, are suitable to facilitate the separation of the half-shells from the interconnecting wall in the transfer onto the industrial-scale of the half-shell production process, wherein it is necessary to use wafer sheets of large dimensions with a high number of half-shells, it has been found that the separation operation, whether performed by compression or cutting, involves significant problems that cause the production of a large number of defective half-shells, for example having a crumbled or jagged mouth contour, resulting in a high loss of productivity.

The object of the present invention is to provide a method that overcomes the aforementioned disadvantages and is thus particularly suitable for being implemented in industrial production by substantially limiting the production of waste and increasing productivity.

In view of such aim, the object of the invention is a method as defined in the following claims, which form an integral part of the present description.

Further advantages and features of the method according to the invention will become apparent from the detailed description that follows, provided with reference to the accompanying drawings, provided by way of non-limiting example, wherein:

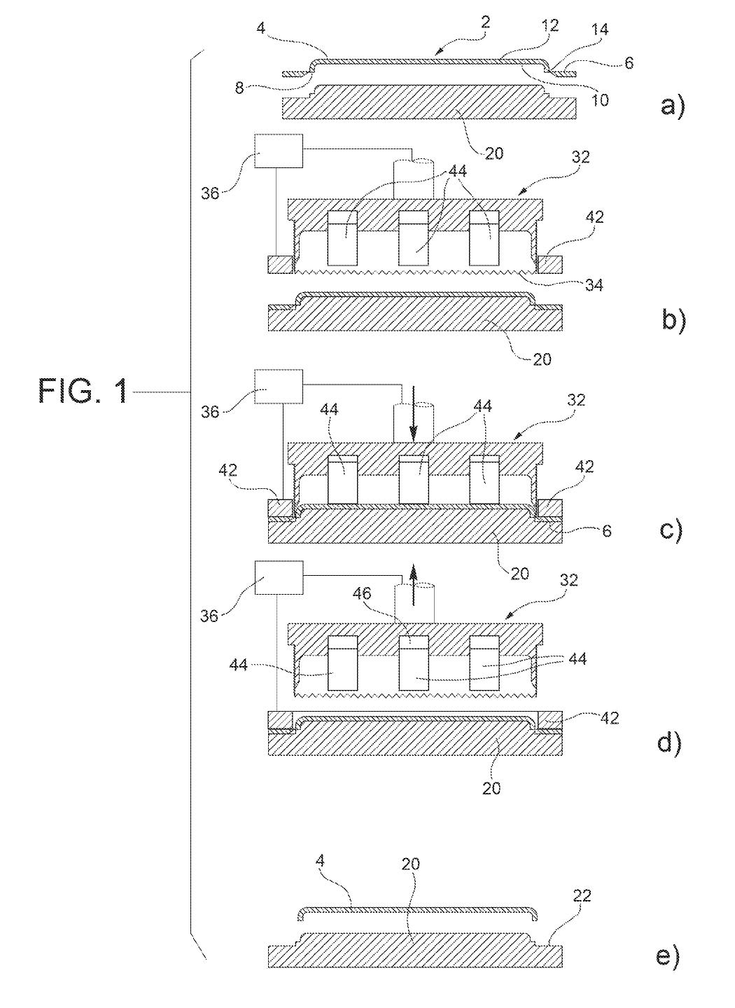

FIG. 1 is a schematic illustration of steps a)-e) of the method starting with step a) wherein the wafer sheet is placed on a support to then be subjected to the punching operation through step e) wherein a half-shell is separated from the wafer;

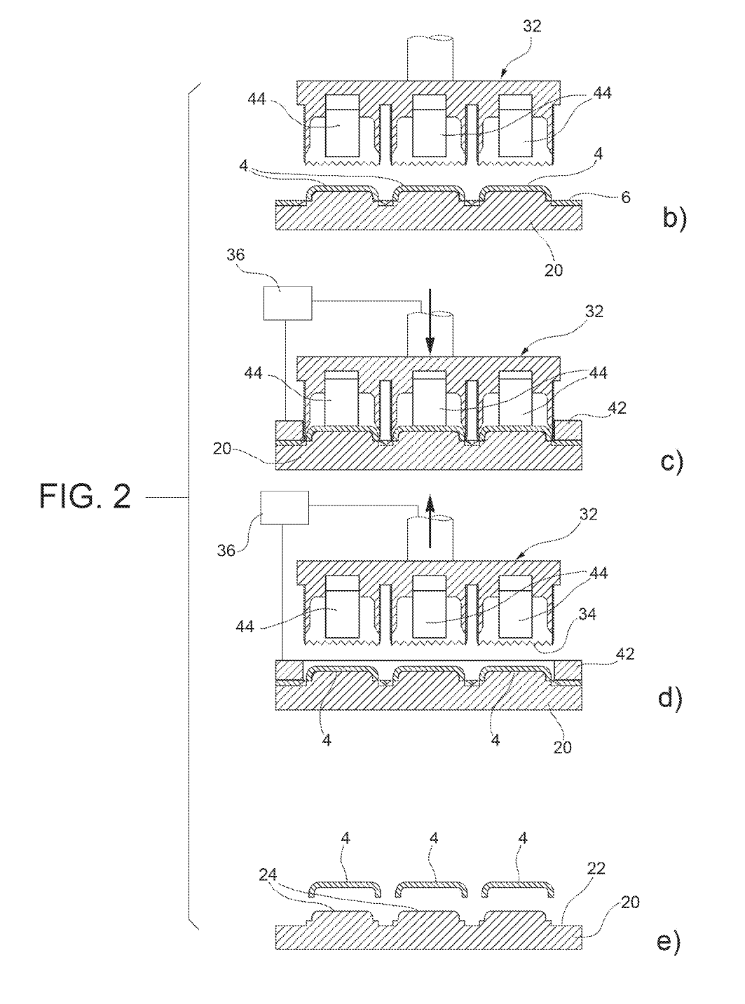

FIG. 2 is a schematic representation of the steps b), c), d) and e) of FIG. 1 showing the cross-sectional views of the corresponding representations in FIG. 1;

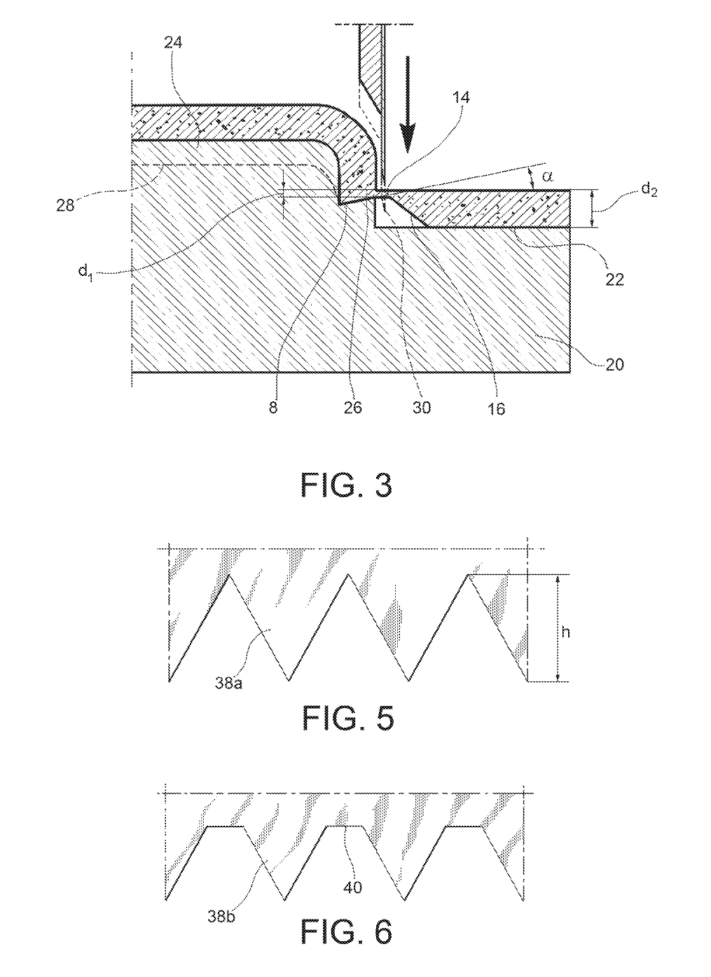

FIG. 3 is a schematic representation of a detail of the punching operation;

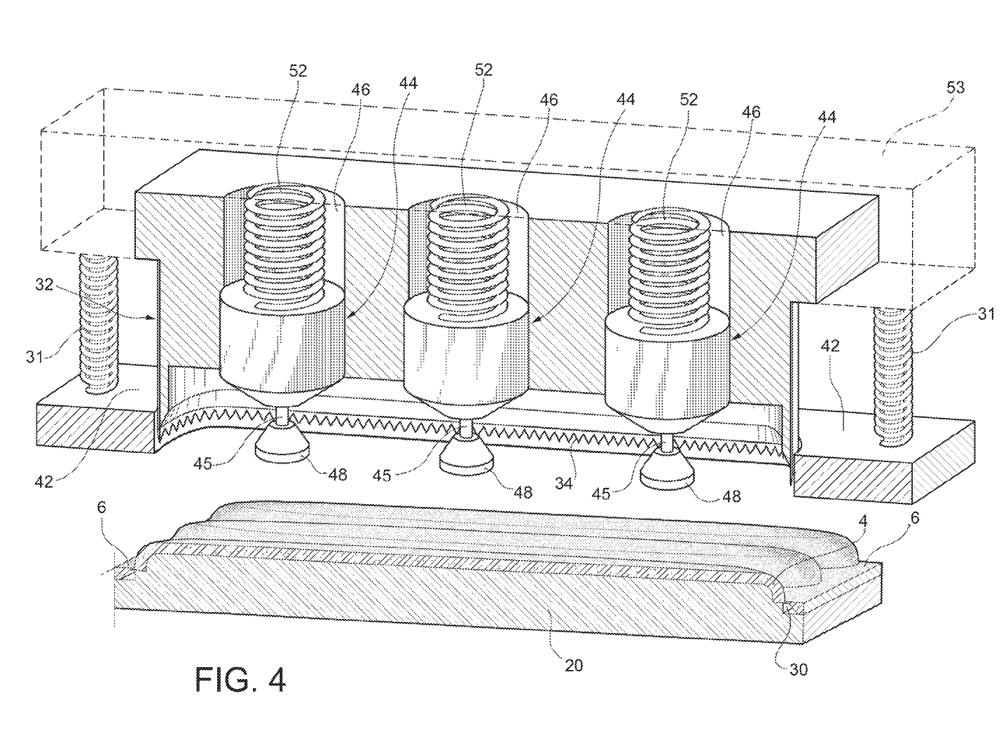

FIG. 4 is a sectional view of a part of the punching apparatus used in the scope of FIG. 1 and FIG. 2;

FIGS. 5 and 6 show two cutting edges of a cutting die, and

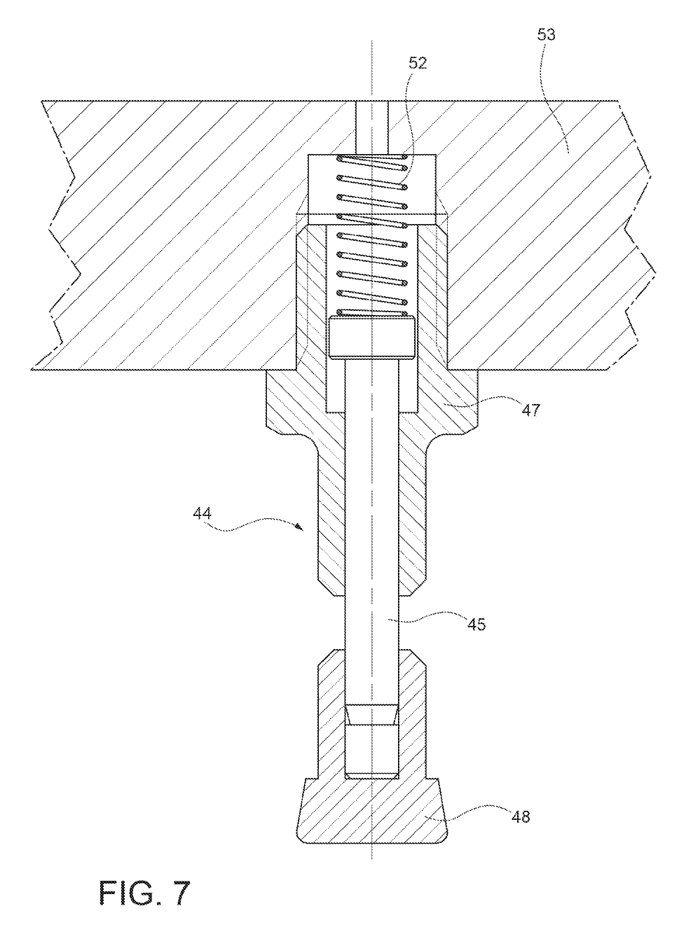

FIG. 7 is a sectional view of the ejector members cooperating with the cutting dies in the cutting operation.

With reference to the drawings, at 2 is indicated a wafer sheet that comprises a plurality of half-shells 4 connected together by an interconnecting wall 6. Although FIGS. 1 and 2 illustrate a single row of half-shells, in industrial production, the wafer will comprise a plurality of half-shells 4 arranged in a matrix, i.e., according to a plurality of rows, generally parallel to each other, and columns parallel to each other and orthogonal to the rows.

The shape of the half-shells is not binding and may be chosen according to the shape of the product that is to be made.

The half-shells 4 have an annular mouth surface 8 which constitutes the connecting surface between the inner surface 10 and the outer surface 12 of the concave wall defining the half-shell; such mouth surface is a finished rim surface since the wafer is obtained by baking in a mold having surfaces in contact with such surface.

The half-shells are connected to the interconnecting wall 6 by means of an annular region or bridge 14 which preferably has a thickness d1 reduced with respect to the thickness d2 of the interconnecting wall (see detail in FIG. 3). In a typical product of this type, d1 is on the order of 0.1-0.8 mm and d2 is on the order of 1 to 3 mm. Preferably, the interconnecting wall 6, adjacent to the aforementioned annular bridge, has a chamfer 16.

As indicated in the cross section detail of FIG. 3, referred to a preferred embodiment, the annular mouth surface 8 is inclined with respect to the general plane of the interconnecting wall, forming with this an angle α preferably approximately 5-15°.

The solution wherein the two half-shells used to produce a closed hollow body have annular mouth surfaces, both inclined (with respect to the junction plane of the two half-shells) with the same inclination, is illustrated in FIGS. 7 and 8 of EP 1 433 386 and is therein described as useful for improving the centering of the two half-shells. However, within the scope of the present invention, such a solution is desirable and advantageous as an additional feature for obtaining a clean cut of the annular region 14 without causing a deterioration of the finished surfaces of the annular mouth rim.

To carry out the separation operation of the half-shells 4 from the wafer sheet 2, the wafer is initially positioned on a support consisting of a supporting plate 20 with at least its interconnecting wall 6 in contact with a complementary surface 22 of said support plate.

The support plate 20 according to the invention is made of a plastic material, preferably polycarbonate.

The support plate 20 is generally a plate other than that wherein the wafer sheet 2 is shaped and baked, as the baking plates in the oven are mostly cast iron plates which are not suitable to support cutting actions. Plate 20 is therefore, preferably, an ad hoc produced support plate whereon the wafer sheet is transferred following its solidification.

In a preferred embodiment, the support plate 20 has a plurality of protruding formations 24 with a shape corresponding to the shape of the half-shells and is furthermore shaped so as to provide a support surface 26 (FIG. 3) for the annular mouth surface 8 of each half-shell, as well as a surface 22 supporting the interconnecting wall 6. However, it is possible to perform the separation operation also with the use of a plate wherein the protruding formations 24 are lowered (for example, by 1-2 tenths of a millimeter) compared to the inner surface 10 of the half-shells; for example, this lowered surface is indicated by the dotted line 28 in FIG. 3.

In another embodiment, however, it is possible to carry out the separation operation also by positioning the wafer sheet with the cavities of the half-shells facing upwards, that is, towards the cutting member, i.e. using a support plate with cavities having concavity facing upwards and with the interconnecting wall 6 supported by a support surface complementary to it as previously indicated.

According to the preferred embodiment shown in FIG. 3, wherein the cavities of the half-shells are facing downward and supported by the formations 24, it is preferable that the annular bridge region 14, where the cutting operation described below is carried out, is not directly supported by the surface of the support plate, thus leaving an empty space 30 underneath the annular region.

The half-shell separation operation is carried out with the use of a plurality of cutting dies or punches 32, each having a cutting profile corresponding to the contour of the half-shell at the aforementioned annular region 14 with reduced thickness.

In practice, in an industrial system, support plates 20 with a respective wafer sheet 2 associated with them are conveyed, e.g. by means of a stepwise movable conveyor, to a temporary stopping position wherein the cutting edge of the cutting dies 32 is in perfect register with the contour of the half-shells as indicated above; alternatively, it is possible to perform the separation operation continuously, i.e. with tracking, so that the cutting dies are movable with a feed rate corresponding to the feed rate of the conveyor which transports the support plates.

In step b) of FIGS. 1 and 2, the cutting dies 32 are positioned above the support plate 20 with their cutting edges 34 in perfect register with the annular region 14; a centering precision on the order of 1-4 tenths of a millimeter is preferable. The cutting-dies 32 are vertically movable and are simultaneously actuated by a motor 36 which drives the translation between the raised position of FIGS. 1b) and 2b) and the lowered position of FIGS. 1c) and 2c) wherein the cutting profile 34 of the cutting dies has notched the annular region 14, stopping adjacent and preferably avoiding contact with the surface 22 of the support plate.

In the scope of the invention, it has been found that, in order to avoid or reduce the production of defective half-shells, the impact of the cutting profile with the annular region 14 and therefore the initial cutting thereof must be made by spaced points or dashes. For this reason, a serrated cutting profile 34 is adopted, preferably with triangular teeth 38a, 38b (FIGS. 5 and 6). It is preferable to have a cutting profile wherein consecutive teeth are joined at an acute angle, as shown in FIG. 5; however, other profiles such as those shown in FIG. 6 may be considered wherein consecutive teeth are connected by a rectilinear section 40. Preferably, the height h of each tooth is greater than the thickness of the interconnecting wall indicated at d1 in FIG. 3.

In combination with a serrated cutting profile, the adoption of an annular mouth rim 8 of the half-shells inclined with respect to the plane of the interconnecting wall, as previously described, further improves the precision of the cut, presumably as it avoids the propagation of the rupture of said annular mouth surface avoiding its deterioration.

The cutting dies and, in particular, their cutting profiles, are generally made of steel, e.g. tool steel.

To optimize the cutting operation, it is preferable that, during its execution, the interconnecting wall 6 of the wafer is bound to the support plate. To this end, the cutting die is preferably associated to a retaining member comprising a stop plate 42, vertically movable, between a raised position and a lowered position for holding the interconnecting wall 6 blocked and thereby in contact with the surface of the support plate. The pressure exerted by the stop plate 42 on the wafer sheet may be adjusted by elastic means, such as helical springs 31.

The stop plate 42 may have a plurality of openings wherein a respective cutting die 32 or a row of cutting dies is movable and is driven, in its vertical motion, by the same motor 36 that controls the vertical translation of the cutting dies, compensating for the extra travel of the springs 31 (FIG. 4). To carry out the cutting operation, the motor 36 causes the advancement of the stop plate 42 from the raised position (FIGS. 1b) and 2b)) to the lowered position (FIGS. 1c) and 2c)) wherein the stop plate 42 binds the interconnecting wall 6 to the support plate. This operation may take place simultaneously with the advancement of the cutting dies 32 towards the support plate 20, however before the cutting dies engage the annular region 14. In conjunction with the retaining action exerted on the wafer sheet by the plate 42, ejector members 44, driven by the motor 36 and compensated, in the descending motion, by springs 52, cooperate with the plate 42 to retain the wafer 4 on the support 20.

As illustrated in FIGS. 4 and 7, one or more movable ejector members 44 is associated with each cutting die, which has the function of preventing the punched half-shell from being held within the respective cutting die 32 during the subsequent movement of the cutting dies away from the support plate. Such ejector members may for example comprise a piston 45 movable within a respective opening 46 made in the body of the cutting die.

FIG. 4 is a schematic representation of a cutting die used in the scope of the method, and provides a sectional perspective view that allows the internal structure to be viewed. In FIG. 4, parts corresponding to the parts illustrated in FIGS. 1 through 3 have the same reference numerals. In particular, in this figure are illustrated the aforementioned ejector members 44, vertically movable in the cylindrical openings 46, and having an end part 48, preferably of elastomeric material such as silicone, adapted to exert pressure on the half-shell 4 following its cutting to prevent its possible engagement within the cutting profile in the ascending motion of the cutting die.

A constructive detail of the ejector members is illustrated in the technical drawing of FIG. 7, wherein elements corresponding to elements of FIG. 4 are indicated with the same reference numerals, although illustrated with a different conformation.

As illustrated, the ejector members 44 comprise a terminal part 48 of elastomeric material, fixed to a sliding, rod-shaped piston 45.

The ejector members 44 are fixed to a vertically movable plate 53, to which the cutting dies 32 are also anchored by means of a threaded rod guide element 47.

An elastic member 52, in the form of a helical spring, exerts pressure on the rod 45 with a defined preload, making sure that the rod exerts on the wafer sheet a force such that it maintains the wafer sheet in position before and after cutting.

Once the cutting operation is performed, the motor 36 drives the vertical movement of the cutting dies away from the support plate 20 and simultaneously or subsequently the vertical movement of the stop plate 42 and that of the ejectors 44, to disengage the interconnecting wall 6 (FIGS. 1d and 2d) and the plurality of half-shells 4 (FIG. 4), as mentioned above.

The process according to the invention, due to its innovative features, provides a substantial increase in productivity, in particular avoiding deterioration or crumbling of the annular rim surface of the half-shells obtained.

Naturally, without prejudice to the principle of the invention, the embodiments and the implementation details may vary from that described and illustrated without departing from the scope of the following claims.

1. Method for producing wafer half-shells comprising the operations of:
providing a wafer sheet comprising a plurality of half-shells connected to each other by an interconnecting wall, where the said interconnecting wall is connected to each half-shell by means of an annular region surrounding the half-shell having a thickness smaller than the thickness of the interconnecting wall, and
separating the half-shells from the interconnecting wall along a cutting profile corresponding to the half-shell contour at said smaller thickness annular region, by means of a cutting operation performed in the direction orthogonal to the plane of the interconnecting wall,
wherein in said separation operation the interconnecting wall is supported by a support made of plastic material, and said separation operation is carried out by means of a cutting member having a serrated cutting profile.

2. Method according to claim 1, wherein in said wafer sheet, said half-shells have an annular mouth surface inclined with respect to the general plane of said interconnecting wall.

3. Method according to claim 2, wherein said annular mouth surface forms an angle from 5° to 15° with respect to the general plane of said interconnecting wall.

4. Method according to claim 1, wherein said support made of plastic material is shaped to support the lower surface of said interconnecting wall and said annular mouth surface.

5. Method according to claim 4, wherein said support comprises a plurality of protruding formations each of a shape complementary to the shape of a respective half-shell, said half-shells being positioned on the support with their cavity facing the support.

6. Method according to claim 1, wherein said support is made of polycarbonate.

7. Method according to claim 1, wherein said interconnecting wall is held in contact with the support by means of a retaining member prior to and during the separation operation.

8. Method according to claim 7, wherein said cutting member is a cutting die movable between a raised position and a cutting position under the action of a motor device, the cutting die being associated with said plate-shaped retaining member which binds the interconnecting wall to the support by keeping it in contact with this before and during the cutting operation.

9. Method according to claim 8, wherein one or more ejector members are associated with each cutting die, which are adapted to keep the cut half-shells in contact with the support following the separation and cutting operation.

10. Method according to claim 9, wherein said one or more ejector members are vertically movable in a corresponding opening in the body of the cutting die.

11. Method according to claim 1, characterized in that said serrated profile has triangular-shaped teeth.

12. Method according to claim 11, characterized in that said triangular-shaped teeth have a height greater than the thickness of the interconnecting wall.
